(19) United States
(12) Patent Application Publication
(10) Pub. No.: US 2026/0312089 A1
(43) Pub. Date: Oct. 8, 2026

(54) DEVICE FOR FILTERING AMBIENT AIR

(71) Applicant: CELLCENTRIC GMBH & CO. KG, Kirchheim/Teck-Nabern (DE)

(72) Inventor: Philipp HAUSMANN, Kirchheim / Teck-Nabern (DE)

(21) Appl. No.: 19/481,437

(22) PCT Filed: May 8, 2024
(86) PCT No.: PCT/EP2024/062822

§ 371 Date: Nov. 4, 2025

(30) Foreign Application Priority Data
May 11, 2023 (DE) 10 2023 204 392.0

(51) Int. Cl. H01M 8/04119; B01D 47/02; H01M 8/04223

(52) U.S. Cl. CPC H01M 8/04156; B01D 47/024; H01M 8/04253

(57) ABSTRACT

The invention relates to a device for filtering ambient air, comprising:
a reactor designed to electrochemically react a reactant with an oxidising agent, wherein at least one fluid can be generated as a product by the electrochemical reaction;
a filter system with a first fluid reservoir;
wherein a first line connection is formed between the reactor and the first fluid reservoir, via which the generated fluid can flow from the reactor to the first fluid reservoir;
wherein the filter system is design to bring ambient air into contact with the generated fluid in the fluid reservoir so that impurities can be filtered out of the ambient air;
wherein a second connecting line is formed between the filter system and the reactor, via which the filtered ambient air of the filter system can be supplied to the reactor as an oxidising agent for the electrochemical reaction.

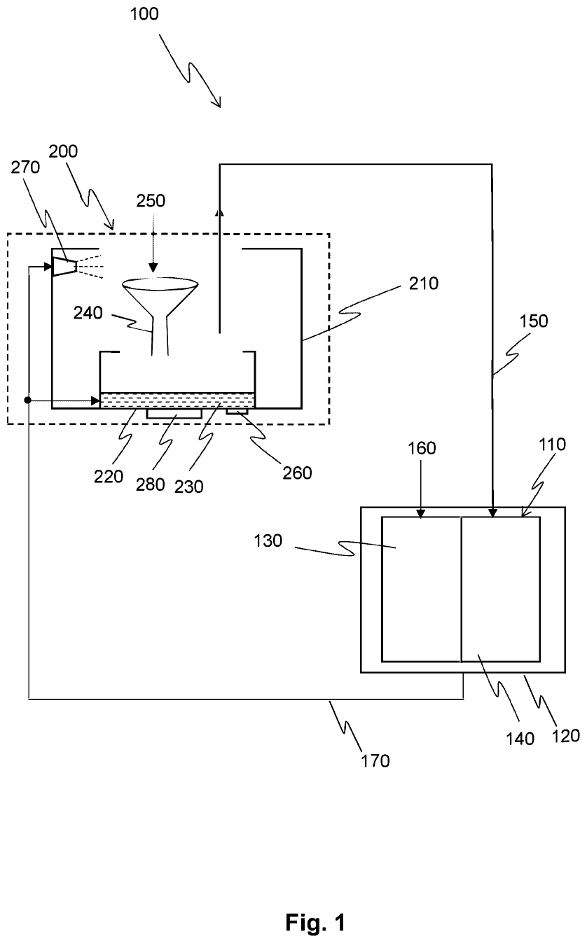

The present invention relates to a device for filtering ambient air, an electrically driven system, and a method for filtering ambient air.

Energy conversion systems are known in which electrical energy can be generated by an electrochemical reaction using an oxidizing agent and a fuel. These systems include fuel cell systems.

A fuel cell system can, for example, be used to generate electrical energy to operate an electric motor for an electrically operated vehicle. The fuel cell system can comprise a fuel cell stack having a plurality of fuel cells arranged side by side. In a fuel cell, an electrolyte layer, in particular a proton-conducting polymer electrolyte membrane, is arranged between two electrodes, a cathode and an anode. In the fuel cell, electrical energy can be generated by a reaction of a fuel with an oxidizing agent, in particular oxygen.

To provide the oxidizing agent, ambient air can first be fed to the fuel cell. In addition to the desired oxidizing agent, the ambient air contains contaminants or pollutants. These contaminants can include ammonia, nitrogen oxides, ozone, sulfur oxides, carbon monoxide, hydrogen sulfide, and others. In addition, the ambient air can also contain dust and salts such as sodium chloride.

These contaminants can adversely affect the electrochemical reaction in the fuel cell and thus the operation of the fuel cell, and can also result in damage to the fuel cell.

It is therefore important that the fuel cell system has a filter system designed to filter out harmful contaminants from the ambient air before it is used for the electrochemical reaction in the fuel cell.

Air filters, in particular paper filters or activated carbon filters, can be used to remove, for example, particulate pollutants and other pollutants from the contaminated ambient air. These air filters have to be cleaned or replaced regularly. This results in additional effort and additional costs. In addition, additional material can be required when replacing the air filters.

The present invention is based on the object of providing a device for filtering ambient air which enables improved sustained operation.

A solution to this object is achieved according to the teaching of the independent claims. Various embodiments and further developments of the invention are the subject matter of the dependent claims.

A first aspect of the solution relates to a device for filtering ambient air, comprising: (i) a reactor, in particular a fuel cell, which is configured to electrochemically react an educt, in particular a fuel, with an oxidizing agent, in particular oxygen, wherein at least one liquid, in particular water, can be generated as a product by the electrochemical reaction; (ii) a filter system having a first liquid reservoir; (iii) wherein a first connecting line is formed between the reactor and the first liquid reservoir, through which the generated liquid can flow from the reactor to the first liquid reservoir; (iv) wherein the filter system is configured to bring ambient air into contact with the generated liquid in the liquid reservoir, so that contaminants, in particular solid or liquid particles, in particular salts, can be filtered out of the ambient air; (v) wherein a second connecting line is formed between the filter system and the reactor, through which the filtered ambient air of the filter system can be supplied to the reactor as an oxidizing agent for the electrochemical reaction.

As possibly used herein, the terms “comprises,” “contains,” “includes,” “encompasses,” “has,” “with,” or any other variant thereof are intended to cover non-exclusive inclusion. For example, a method or a device that comprises or has a list of elements is not necessarily restricted to these elements, but may include other elements that are not expressly listed or that are inherent to such a method or such a device.

Furthermore, unless expressly stated to the contrary, “or” refers to an inclusive “or” and not to an exclusive “or”. For example, a condition A or B is met by one of the following conditions: A is true (or present) and B is false (or absent), A is false (or absent) and B is true (or present), and both A and B are true (or present).

The terms “a” or “an” as used herein, are defined in the meaning of “one or more”. The terms “another” and “a further” and any other variant thereof are to be understood to mean “at least one other”.

The term “plurality” as used herein is to be understood to mean “two or more”.

The term “configured” or “designed” to perform a specific function (and respective modifications thereof), as used herein, is to be understood to mean that the corresponding device is already provided in an embodiment or setting in which it can execute the function or is at least settable—i.e. configurable—so that it can execute the function after corresponding setting. The configuration can take place, for example, via a corresponding setting of parameters of a process course or of switches or the like for activating or deactivating functionalities or settings. In particular, the device can have multiple predetermined configurations or operating modes, so that the configuration can be carried out by selecting one of these configurations or operating modes.

The term “fuel cell” as used here is to be understood in particular as a device in which chemical energy is converted by an electrochemical reaction of a fuel with an oxidizing agent directly into electrical energy. For this purpose, an electrolyte layer can be provided in the fuel cell between two layers designed as electrodes. The electrolyte layer is designed, for example, as a polymer electrolyte membrane (PEM), which has to be moist during operation in order to be able to conduct protons. A fuel, such as hydrogen, is dissociated at an electrode provided as an anode. The resulting protons can diffuse through the membrane to the electrode used as the cathode and react there with an oxygen atom of the oxidizing agent reduced by the cathode, wherein water is formed (formally: 2 H⁺+O²⁻→H₂O).

By means of the device according to the first aspect, before supplying ambient air to the reactor for the electrochemical reaction, the ambient air can be filtered by liquid, in particular water, generated by the reactor. The water is generated by the electrochemical reaction or the water is a product of the electrochemical reaction. Therefore, no separate air filter, which would have to be replaced regularly, is required to filter the ambient air. In this respect, potential maintenance effort and also material expenditure can be reduced. Likewise, in the present device it is not necessary to provide liquid for the filtering from an external liquid source. Rather, the liquid generated by the device itself can be used. This can further reduce the expenditure required to operate the filter. The device can therefore be operated sustainably and with comparatively little expenditure. In this respect, the present device can be described as a self-renewing device with regard to the use of liquid generated by the device for filtering the ambient air.

Preferred embodiments of the device are described hereinafter, which in each case, unless expressly excluded or technically impossible, can be combined as desired with one another and with the further described other aspects.

In some embodiments, the filter system comprises a gas separation device, in particular a centrifugal separator, which is configured to separate liquid or solid particles contained in the ambient air from the ambient air depending on a physical property of the particles, in particular their mass, before the filtering by the liquid, and to bring them into contact with the liquid. This allows the ambient air to be filtered more effectively, since in this way the particles are fed to the liquid depending on the physical property, whereas gas molecules that are lighter than the particles are not fed to the liquid.

In some embodiments, the filter system comprises a humidification device, in particular a spray device, which is configured to humidify ambient air flowing into the filter system. In particular water-soluble substances, such as salts, which can be contained in the ambient air, can in this way be bound and more effectively fed to the liquid, and thus filtered out of the ambient air.

In some embodiments, the filter system comprises a heating device for heating the first liquid reservoir. This allows the liquid in the liquid reservoir to be heated and, in particular, prevents the liquid from freezing at outside temperatures below the freezing point. Freezing of the liquid would have the result that the ambient air could no longer be filtered or at least could only still be filtered to a greatly reduced extent, and thus largely unfiltered ambient air would be fed to the reactor. Furthermore, the heating device can achieve a temperature of the liquid preferred for the operation of the device. Likewise, after a prolonged shutdown of the reactor during which the liquid was frozen, the heating device can enable the liquid to be thawed, in particular before the reactor is put into operation.

In some embodiments, the device comprises an electrically controlled pump for conveying a predetermined volume of the generated liquid from the reactor to the liquid reservoir. This can ensure a predetermined volume of liquid in the liquid reservoir. This can be advantageous if the liquid reservoir is operated in continuous flow, i.e. the liquid is continuously fed to the liquid reservoir by the pump and also continuously flows out of the liquid reservoir again.

In some embodiments, the first liquid reservoir has a closable opening through which liquid can be discharged from the first liquid reservoir. This allows liquid in which pollutants from the ambient air have been bound or dissolved to be drained from the liquid reservoir, and the liquid reservoir can be refilled using liquid from the reactor. This allows pollutants from the environment to be filtered out better.

In some embodiments, the closable opening has a continuously open state. This allows the liquid to be continuously drained and liquid from the reactor to be continuously refilled into the liquid reservoir. This can achieve even more effective filtration of the ambient air.

In some embodiments, the device comprises a second liquid reservoir for the generated liquid. This allows a portion of a volume quantity of the liquid that can be generated by the reactor to be stored in the second liquid reservoir for an application different from the filtering of the ambient air. In particular, when the device is used in a motor vehicle, the generated liquid can be used for lubrication, for a windshield wiper system, or for extinguishing or cooling components. In this way, the generated liquid can be fed to an additional use, and a saving of a liquid that was intended in the vehicle for one or more of the above-mentioned uses can be achieved.

In some embodiments, the device comprises: (i) a housing in which the reactor is arranged, wherein the housing is connected to the filter system by a third connecting line; (ii) a gas pump, in particular a gas jet pump, which is configured to aspirate gas from the housing of the reactor and feed it to the filter system via the third connecting line. In particular in operation of the reactor, gas in the housing can come into contact with dirt particles from the reactor. On the one hand, this gas is aspirated out of the housing by the gas pump. On the other hand, this gas is filtered by the filter system and accordingly fed back to the reactor by the filter system. This allows a gas present in the housing to be removed and used for the electrochemical reaction.

In some embodiments, the reactor comprises a fuel cell. The fuel cell generates water, in particular water, in operation. In particular, a truck can generate a volume of water in the order of magnitude of 70 l over a distance in the order of magnitude of 100 km. This volume can be sufficient for filtering the ambient air and for other applications. In the case of a fuel cell arranged in the housing, the tightness of the fuel cell can be reduced after a longer period of time, due to which small amounts of gas, in particular hydrogen, can pass from the fuel cell into the housing. The aspiration of this hydrogen by the gas pump, can prevent this hydrogen from escaping into the environment.

A second aspect of the solution relates to an electrically driven system comprising a device according to the first aspect.

In some embodiments, the electrically driven system comprises a motor vehicle or an emergency power generator for an energy supply system.

A third aspect of the solution relates to a method for filtering ambient air, comprising: (i) carrying out an electrochemical reaction with an educt, in particular a fuel, and an oxidizing agent, in particular oxygen, by way of a reactor, wherein at least one liquid is generated as a product by the electrochemical reaction; (ii) feeding the generated liquid to a liquid reservoir of a filter system, wherein the ambient air is brought into contact with the generated liquid by the filter system, so that contaminants are filtered out of the ambient air; (iii) feeding the filtered ambient air to the reactor for an electrochemical reaction.

The features and advantages explained with respect to the first aspect of the solution also apply correspondingly to the further described aspects.

Further advantages, features, and possible applications result from the following more detailed description of preferred embodiments in conjunction with the figures.

The FIGURE schematically shows a fuel cell system 100 having a fuel cell 110 and a filter system 200 according to an embodiment.

The fuel cell 110 is arranged in a housing 120. The fuel cell 110 comprises an anode chamber 130 and a cathode chamber 140. An anode (not shown here) is arranged in the anode chamber 130 and a cathode (not shown here) is arranged in the cathode chamber 140. A proton-conducting membrane, in particular a polymer electrolyte membrane (not shown here), is arranged between the anode and the cathode. An oxidizing agent is fed to the cathode chamber by an oxidizing agent line 150. A fuel is fed to the anode chamber 130 by a fuel line 160. In the fuel cell 110, an electrochemical reaction takes place between the oxidizing agent and the fuel, wherein electrical energy is generated, as well as water as a reaction product. This water is fed by a water line 170 to a liquid reservoir 220 by means of a controlled pump (not shown here) of a filter system 200. The water line is made of a corrosion-resistant material, especially stainless steel.

The filter system 200 furthermore comprises a filter housing 210 in which the liquid reservoir 220 is arranged. Ambient air is fed through an opening of the filter housing 210 by an ambient air line 250. For this purpose, an appropriate air conveying device (not shown here) can be used. The fed ambient air is pre-filtered by a centrifugal separator 240 so that contaminants in the ambient air, in particular liquid or solid particles such as salt particles, which are heavier than the gas molecules of the ambient air, are fed to the liquid reservoir 220 having the water. There, these contaminants are bound by the water or dissolve in the water. The corresponding gas flow can be directed not only towards the water surface, but also through the water 230, by which a particularly effective separation of the ambient air from remaining contaminants can be achieved. These contaminants can comprise, in particular, ammonia or salts.

The gas molecules, which are comparatively lighter than the contaminants, in particular oxygen, rise upward again and are fed to the cathode chamber 140 as an oxidizing agent by the oxidizing agent line 150.

The liquid reservoir 220 furthermore comprises a closable opening 260 through which the water 230 can be discharged. This can be advantageous if contaminants from the ambient air have already been filtered out by the water 230 over a longer period of time and have thus been bound by the water 230, and the water has been saturated in this way. Saturated water or filter water can insofar be discharged from the liquid reservoir 220 through the closable opening 260 and replaced by unsaturated water 230.

It is also possible for the water 230 to be continuously replaced, i.e. to flow continuously through the liquid reservoir 220.

Furthermore, the filter system 200 can comprise a spray device 270 by which the ambient air fed to the filter system 200 can be sprayed with water droplets. The filter system 200 would accordingly also be functional without the spray device 270. The water 230 required for this purpose is fed to the spray device 280 via the water line 170. Substances that are water-soluble are bound by the water droplets and thus fed to the liquid reservoir 220.

Furthermore, the filter system 200 comprises a heating device 280, which is arranged below the liquid reservoir 220 with respect to the plane of the drawing, in order to supply heat to the liquid reservoir 220 if necessary. This is particularly advantageous at outside temperatures below the freezing point of the water 230 in order to prevent the water 230 from freezing. Likewise, the heating device 280 can enable the water 230 to thaw if, for example, a vehicle having the fuel cell system was parked for a longer period of time at temperatures below freezing, and the water 230 was frozen as a result. As a result, the water 230 can be kept in a liquid state or brought into a liquid state by the heating device 280, by which filtering of the ambient air by the filter system can be ensured.

In the filter system 200, which can also be referred to as a liquid bath filter, supplied ambient air is filtered by the water 230 and fed to the fuel cell 110 for generating electrical energy using an electrochemical reaction. The water 230 is in turn a product of this electrochemical reaction, so that as a result the present fuel cell system 100 is self-renewing.

While at least one exemplary embodiment has been described above, it is to be noted that a large number of variations thereto exist. It is also to be noted that the exemplary embodiments described only represent non-limiting examples, and are not intended to restrict the scope, the applicability, or the configuration of the devices and methods described herein. Rather, the preceding description will provide those skilled in the art with guidance for implementing at least one exemplary embodiment, wherein it is apparent that various changes in the operation and arrangement of elements described in an exemplary embodiment may be made without departing from the scope of the subject matter defined in the appended claims and their legal equivalents.

### LIST OF REFERENCE NUMERALS

100 fuel cell system
110 fuel cell
120 fuel cell housing
130 anode chamber
140 cathode chamber
150 oxidizing agent line
160 fuel line
170 water line
200 filter system
210 filter housing
220 liquid reservoir
230 water
240 centrifugal separator
250 ambient air line
260 closable opening
270 spraying device
280 heating device

What is claimed is:

1. A device for filtering ambient air, comprising:
a reactor which is configured to electrochemically react a reactant with an oxidizing agent, wherein at least one liquid can be generated as a product by the electrochemical reaction;
a filter system having a first liquid reservoir;
wherein a first line connection is formed between the reactor and the first liquid reservoir, through which the generated liquid can flow from the reactor to the first liquid reservoir;
wherein the filter system is configured to bring ambient air into contact with the generated liquid in the liquid reservoir so that contaminants can be filtered out of the ambient air;
wherein a second connecting line is formed between the filter system and the reactor, through which the filtered ambient air of the filter system can be fed to the reactor as an oxidizing agent for the electrochemical reaction.

2. The device according to claim 1, wherein the filter system comprises a gas separation device which is configured to separate liquid or solid particles contained in the ambient air from the ambient air depending on a physical property of the particles before the filtering by the liquid, and to bring the particles into contact with the liquid.

3. The device according to 1, comprising a humidification device which is configured to humidify ambient air flowing into the filter system.

4. The device according to claim 1, comprising a heating device for heating the first liquid reservoir.

5. The device according to claim 1, comprising an electrically controlled pump for conveying a predetermined volume of the generated liquid from the reactor to the liquid reservoir.

6. The device according to claim 1, wherein the first liquid reservoir has a closable opening through which liquid can be discharged from the first liquid reservoir.

7. The device according to claim 6, wherein the closable opening has a continuously open state.

8. The device according to claim 1, comprising a second liquid reservoir for the generated liquid.

9. The device according to claim 1, furthermore comprising:
a housing in which the reactor is arranged, wherein the housing is connected to the filter system by a third connecting line;
a gas pump which is configured to aspirate gas from the housing of the reactor and to feed it to the filter system via the third connecting line.

10. The device according to claim 1, wherein the reactor comprises at least one fuel cell.

11. An electrically driven system comprising a device according to claim 1.

12. The electrically driven system according to claim 11, comprising a motor vehicle or an emergency power generator for an energy supply system.

13. A method for filtering ambient air, comprising:
carrying out an electrochemical reaction with a reactant and an oxidizing agent by way of a reactor, wherein at least one liquid is generated as a product by the electrochemical reaction;
feeding the generated liquid to a liquid reservoir of a filter system, wherein the ambient air is brought into contact with the generated liquid by the filter system so that contaminants are filtered out of the ambient air;
feeding the filtered ambient air to the reactor for an electrochemical reaction.

14. The device according to claim 2, comprising a humidification device which is configured to humidify ambient air flowing into the filter system.

15. The device according to claim 2, comprising a heating device for heating the first liquid reservoir.

16. The device according to claim 3, comprising a heating device for heating the first liquid reservoir.\

17. The device according to claim 2, comprising an electrically controlled pump for conveying a predetermined volume of the generated liquid from the reactor to the liquid reservoir.

18. The device according to claim 3, comprising an electrically controlled pump for conveying a predetermined volume of the generated liquid from the reactor to the liquid reservoir.

19. The device according to claim 2, wherein the first liquid reservoir has a closable opening through which liquid can be discharged from the first liquid reservoir.

20. The device according to claim 2, comprising a second liquid reservoir for the generated liquid.
